(19) United States
(12) Patent Application Publication
(10) Pub. No.: US 2024/0375532 A1
(43) Pub. Date: Nov. 14, 2024

(54) CHARGING WAKE-UP CIRCUIT, CHARGING SOCKET AND ELECTRIC VEHICLE

(71) Applicant: Changchun Jetty Automotive Technology Co., Ltd., Changchun, Jilin Province (CN)

(72) Inventors: Chao WANG, Changchun (CN); Xupeng HAN, Changchun (CN)

(21) Appl. No.: 18/690,662

(22) PCT Filed: Sep. 9, 2022
(86) PCT No.: PCT/CN2022/118133

§ 371 Date: Mar. 8, 2024

(30) Foreign Application Priority Data
Sep. 10, 2021 (CN) 202122196490.5

(51) Int. Cl. B60L 53/16; B60L 58/10

(52) U.S. Cl. CPC B60L 53/16; B60L 58/10

(57) ABSTRACT

The present disclosure relates to the technical field of electric vehicle charging, and in particular to a charging wake-up circuit, a charging socket and an electric vehicle. The charging wake-up circuit includes: a state signal detection unit and a wake-up signal output unit. The state signal detection unit is configured to generate a state input signal based on an open state and a closed state of a charging socket cover of an electric vehicle; and an input end of the wake-up signal output unit is connected to an output end of the state signal detection unit, an output end of the wake-up signal output unit is connected to a charging socket control unit of the electric vehicle, and the wake-up signal output unit is configured to output, based on the state input signal, a change in a level signal to serve as a wake-up signal for the charging socket control unit. The charging wake-up circuit of the present disclosure has low costs, is low in power consumption and has good anti-interference performance, and the charging socket control unit can directly acquire the wake-up signal, so that the response speed is high.

The present application claims priority to Chinese Patent Application No. 202122196490.5, filed on Sep. 10, 2021, and entitled “CHARGING WAKE-UP CIRCUIT. CHARGING SOCKET AND ELECTRIC VEHICLE”, which is hereby incorporated by reference in its entirety.

### TECHNICAL FIELD

The present disclosure relates to the technical field of electric vehicle charging, and in particular to a charging wake-up circuit, a charging socket and an electric vehicle.

### BACKGROUND

With the development of science and technology and the increasingly severe energy problems, new energy gradually grows into the backbone of resources, and in terms of the automotive field, electric vehicle technology has developed rapidly under the support and advocacy of new energy technology by the state.

New energy vehicles are usually equipped with power batteries to output power, and the power battery may be a lithium battery. A BMS (Battery Management System) is the core of the power battery, which is responsible for controlling charging and discharging of the power battery and implementing battery state estimation and other functions.

The power supply in a charging pile is connected with the power grid, obtains electric energy from the power grid, and converts the alternating current obtained from the power grid into direct current for charging use. The charging pile includes at least a control assembly and a power supply in the interior. The control assembly can receive request information sent by the BMS of the electric vehicle, and can send a corresponding control signal to control connection between the power supply and the electric vehicle at different power supply stages according to the actual operation.

The charging socket is a device installed on the electric vehicle and used to be connected to a charging interface of the charging pile. It is usually necessary to wake up the charging socket before further judging whether the power battery needs to be charged by the charging pile. At present, the method of waking up the charging socket is usually to wake up a CAN (Controller Area Network) chip of the electric vehicle first by a hard-wire signal, and then wake up the on-board charging socket by the CAN chip. The response speed is slow, and the signal transmitted through the CAN bus has poor anti-interference ability, which may lead to unstable signal transmission.

### SUMMARY

Embodiments of the present disclosure provide a charging wake-up circuit, which is used to solve the problems of slow wake-up response speed of the charging socket and unstable wake-up signal transmission.

The embodiments of the present disclosure provide the specific technical solution as follows.

In a first aspect, a charging wake-up circuit is provided, which is applied to an electric vehicle and includes:
a state signal detection unit configured to generate a state input signal based on an open/closed state of a charging socket cover of the electric vehicle; and
a wake-up signal output unit, an input end of the wake-up signal output unit being connected to an output end of the state signal detection unit, and an output end of the wake-up signal output unit being connected to a charging socket control unit of the electric vehicle, and the wake-up signal output unit being configured to output, based on the state input signal, a change in a level signal to serve as a wake-up signal for the charging socket control unit.

In a second aspect, a charging socket is provided, which includes a charging wake-up circuit according to the above embodiment, to solve the problems of slow wake-up response speed of the charging socket and unstable wake-up signal transmission.

In a third aspect, an electric vehicle is provided, which includes a charging socket described above, to solve the problems of slow wake-up response speed of the charging socket and unstable wake-up signal transmission.

The present disclosure has the advantageous effects as below:

In the embodiment of the present disclosure, the state signal detection unit of the charging wake-up circuit is configured to generate a state input signal based on an open/closed state of a charging socket cover of an electric vehicle; the wake-up signal output unit is configured to output, based on the state input signal, a change in a level signal to serve as a wake-up signal for the charging socket control unit. The wake-up signal output unit is directly connected to a Micro-control Unit (MCU) of the charging socket, without the need to achieve to wake up the charging socket via the CAN bus of the electric vehicle. That is to say, the user can directly wake up the charging socket through the operation on a cover of the charging socket. The charging wake-up circuit according to the embodiment of the present disclosure has low costs, is low in power consumption and has good anti-interference performance, and the charging socket control unit can directly acquire the wake-up signal, so that the response speed is high.

### BRIEF DESCRIPTION OF THE DRAWINGS

In order to more clearly illustrate the technical solution in the embodiments of the present disclosure, drawings that need to be used in illustration of the embodiments will be simply introduced below, obviously the drawings in the following description are merely some embodiments of the present disclosure, for persons ordinarily skilled in the art, it is also possible to obtain other drawings according to these drawings without making inventive efforts.

FIG. 1 is a structural schematic diagram of a charging wake-up circuit according to the embodiment of the present disclosure.

### DESCRIPTION OF EMBODIMENTS

In order to realize fast wake up of the charging socket, and at the same time to realize low power consumption of the circuit and stability of wake up signal transmission, the embodiments of the present disclosure provide a charging wake-up circuit, a charging socket and an electric vehicle.

The exemplary embodiments of the present disclosure are described below in conjunction with the drawings of the specification. It should be understood that the exemplary embodiments described herein are used only to illustrate and interpret the present disclosure, not to limit the present disclosure, and that the embodiments in the present disclosure and features in the embodiments may be combined with each other without conflict.

### First Embodiment

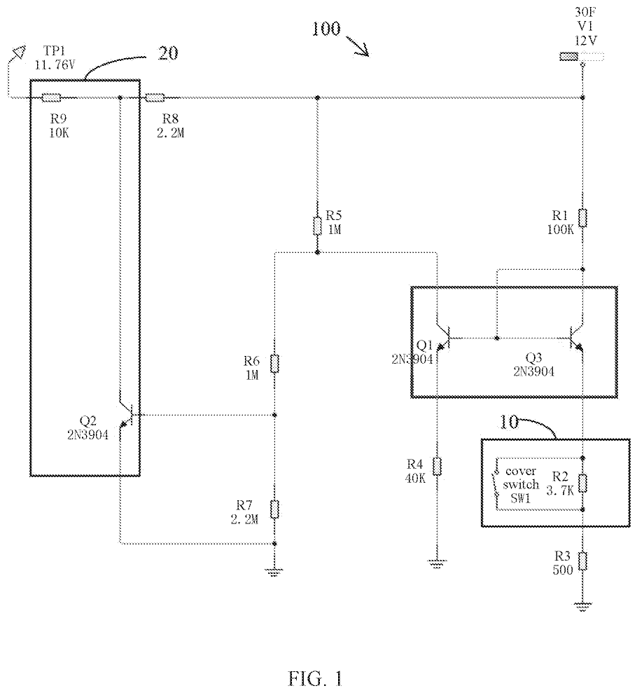

Referring to FIG. 1, which is a structural schematic diagram of a charging wake-up circuit according to the embodiment of the present disclosure, the charge wake-up circuit according to the embodiment of the present disclosure is illustrated below in details in combination with FIG. 1.

As shown in FIG. 1, the charging wake-up circuit 100 according to this embodiment is used for an electric vehicle and specifically includes a state signal detection unit 10 and a wake-up signal output unit 20. The state signal detection unit 10 is configured to generate a state input signal based on an open state and a closed state of a charging socket cover of the electric vehicle. An input end of the wake-up signal output unit 20 is connected to an output end of the state signal detection unit 10, an output end of the wake-up signal output unit 20 is connected to a charging socket control unit of the electric vehicle, and the wake-up signal output unit is configured to output, based on the state input signal, a change in a level signal to serve as a wake-up signal for the charging socket control unit.

It should be noted that the charging socket control unit may be an MCU. It can be understood that when the operator connects the power supply of the charging pile to the charging socket through a charging gun, the action to the charging socket cover may be triggered. Thus, the MCU of the charging seat can be directly woken up by a change in the open/closed state of the charging socket cover.

In addition, since the control assembly in the charging pile can receive request information sent by the BMS of the electric vehicle, and can send a corresponding control signal to control connection between the power supply and the electric vehicle under different power supply stages according to the actual operation, after the charging socket is woken up, if it is necessary to supply power to the power battery (accumulator) in the electric vehicle, after the BMS sends a charging request signal to the control assembly of the charging pile, the control assembly sends a charging connection signal to the MCU of the charging socket, and then the MCU determines whether to connect the power supply of the charging pile to the power battery of the electric vehicle to achieve charging.

The charging wake-up circuit 100 according to the present disclosure has low costs. is low in power consumption and has good anti-interference performance, and the charging socket control unit can directly acquire the wake-up signal, that the response speed is high.

Specifically, the state signal detection unit 10 includes a control switch SW1 and a second resistor R2. The control switch SW1 is connected in parallel with the second resistor R2. One end of the second resistor R2 is connected to an on-board power supply of the electric vehicle and the input end of the wake-up signal output unit 20 respectively, and the other end of the second resistor R2 is grounded.

It can be understood that the control switch SW1 and the second resistor R2 are used to simulate the open/closed state of the charging socket cover.

In the embodiment of the present disclosure, the control switch SW1 may be configured to be turned off when the charging socket cover is in the closed state; and to be turned on when the charging socket cover is in the open state.

Correspondingly, the wake-up signal output unit 20 may be configured to: output a high-level signal as a wake-up signal for the charging socket control unit when the control switch SW1 is in an off state, that is, when the charging socket cover is in the closed state; and output a low-level signal as the wake-up signal for the charging socket control unit when the control switch SW1 is in an on state, that is, when the charging socket cover is in the open state.

Thus, based on the change of the high-level signal and low-level signal, the MCU of the charging socket can be woken up.

Specifically, the charging wake-up circuit 100 of the present disclosure further includes a state signal stabilization unit. An input end of the state signal stabilization unit is connected to the output end of the state signal detection unit 10, and an output end of the state signal stabilization unit is connected to the input end of the wake-up signal output unit 20, for stabilizing the state input signal.

As shown in FIG. 1, the state signal stabilization unit includes a first transistor Q1 and a third transistor Q3. The first transistor Q1 and the third transistor Q3 constitute a proportional constant-current source configured to provide a constant-current state input signal to the wake-up signal output unit 20.

More specifically, the state signal stabilization unit further includes a fourth resistor R4 and a third resistor R3. The fourth resistor R4 serves as a negative feedback resistor for the first transistor Q1, and the third resistor R3 and the second resistor R2 serve as negative feedback resistors for the third transistor Q3 based on the on and off of the control switch SW1, for stabilizing an operating point of the proportional constant-current source.

More specifically, the state signal stabilization unit further includes a first resistor R1, one end of the first resistor R1 is connected to the on-board power supply (in this embodiment, the voltage of the on-board power supply is 12 V, and the on-board power supply supplies power continuously to the charging wake-up circuit 100), and the other end of the first resistor R1 is connected to a first switching end of the third transistor Q3, a second switching end of the third transistor Q3 is connected to one end of the second resistor R2, and the other end of the second resistor R2 is connected to one end of the third resistor R3, and the other end of the third resistor R3 is grounded. A first control end of the first transistor Q1 is connected to a second control end of the third transistor Q3, a first switching end of the first transistor Q1 is connected to the input end of the wake-up signal output unit 20, and a second switching end of the first transistor Q1 is grounded via the fourth resistor R4. A common end of the first control end and the second control end is connected between the first resistor R1 and the first switching end of the third transistor Q3. Thus, the wake-up signal output unit 20 outputs a relatively stable state input signal.

In this embodiment, the resistance value of the first resistor R1 may be selected in the range of 0.5 MΩ to 1.2 MΩ (including the endpoint values). The resistance value of the second resistor R2 can be selected in the range of 3.3 KΩ to 4 KΩ (including the endpoint values).

In this embodiment, the first transistor Q1 and the third transistor Q3 are NPN triodes with the same characteristics, as shown in FIG. 1. Therefore, it can be understood that the first switching end of the first transistor Q1 is a collector of a first triode, the second switching end of the first transistor Q1 is an emitter of the first triode, and the first control end of the first transistor Q1 is a base of the first triode. Similarly, the first switching end of the second transistor Q2 is a collector of a second triode, the second switching end of the second transistor Q2 is an emitter of the second triode, and a third control end of the second transistor Q2 is a base of the second triode.

More specifically, the wake-up signal output unit 20 further includes a second transistor Q2, the third control end of the second transistor Q2 may be connected to the first switching end of the first transistor Q1 via a sixth resistor R6, the first switching end of the second transistor Q2 may be connected to a signal input end of the charging socket control unit via a ninth resistor R9, and the second switching end of the second transistor Q2 is grounded.

In this embodiment, the second transistor Q2 is a NPN triode. Therefore, it can be understood that the base of the second triode is connected to the collector of the first triode via the sixth resistor R6, the collector of the second triode is connected to the signal input end of the charging socket control unit via the ninth resistor R9, and the emitter of the second triode is grounded.

Therefore, it can be further understood that in this embodiment, when the control switch SW1 is in the off state, that is, when the charging socket cover is closed, the second resistor R2 is connected into the charging wake-up circuit 100, thus, the current flowing through the third transistor Q3 is very low, and the current flowing through the first transistor Q1 is also very low, which then causes the second transistor Q2 to be turned off, to output a high-level to the MCU of the charging socket via the ninth resistor R9 to wake up the charging socket.

Similarly, when the control switch SW1 is in the on state, that is, when the charging socket cover is open, the second resistor R2 is not connected into the charging wake-up circuit 100, thus, the current flowing through the third transistor Q3 is relatively high, and the current flowing through the first transistor Q1 is also relatively high, which then causes the second transistor Q2 to be turned on, to output a low-level to the MCU of the charging socket via the ninth resistor R9 to wake up the charging socket.

Therefore, the charging socket can be woken up by the changing of the high-level signal and low-level signal of the MCU port.

Further, the charging wake-up circuit 100 of the present disclosure further includes a seventh resistor R7, a third control end (i.e., a base) of the second transistor Q2 is also grounded via the seventh resistor R7 to be able to provide an appropriate forward-bias to the emitter of the second transistor Q2.

Further, the charging wake-up circuit 100 of the present disclosure further includes a fifth resistor R5, one end of the fifth resistor R5 is connected to an on-board power supply of 12 V, and the other end of the fifth resistor R5 is connected to the sixth resistor R6 and the first switching end of the first transistor Q1 respectively.

Further, the charging wake-up circuit 100 of the present disclosure further includes an eighth resistor R8, one end of the eighth resistor R8 is connected to the on-board power supply of 12 V, and the other end of the eighth resistor R8 is connected to the ninth resistor R9, thus providing the MCU of the charging socket with an appropriate working voltage.

From the above illustration of the charging wake-up circuit 100 of this embodiment, it can be seen that the power supply voltage of 12V exists all the time, and the current consumption needs to be reduced in order to achieve the low power consumption of the circuit. Specifically, the charging wake-up circuit 100 of this embodiment can be divided into four branches, namely, a first branch, which refers to that the power supply is output to the MCU of the charging socket via the eighth resistor R8 and the ninth resistor R9, and because the pin of the MCU is set to be in a high impedance state, the current consumption is very little; a second branch, which refers to that the control of second transistor Q2 to be turned on and off is achieved through this branch including the fifth resistor R5, the sixth resistor R6 and the seventh resistor R7, therefore, it is necessary to set a resistor with an appropriate high resistance value to reduce loss, and the fifth resistor R5 is set in a range of 0.5 MΩ to 1.2 MΩ (including the endpoint values), the sixth resistor R6 may also be set in a range of 0.5 MΩ to 1.2 MΩ (including the endpoint values), the seventh resistance R7 may be set in a range of 2 MΩ to 3 MΩ (including the endpoint values); a third branch, which refers to: a branch including the fifth resistor R5, the first transistor Q1 and the fourth resistor R4, and because when the control switch SW1 is turned off, equivalent to that the first transistor Q1 is turned off, basically no current flows through, therefore, the consumption is little; a fourth branch, which refers to a branch including the first resistor R1, the third transistor Q3, the second resistor R2 and the third resistor R3, in which when the control switch SW1 is turned off, equivalent to that the third transistor Q3 is turned off, and basically no current flows through. Therefore, the charging wake-up circuit 100 of this embodiment has low power consumption.

In the charging wake-up circuit 100 of this embodiment, the appropriate second resistor R2 is selected first, for example, the resistance value of the second resistor R2 is 3.7 kΩ. and then the resistance values of the first resistor R1, the fifth resistor R5, the sixth resistor R6 and the seventh resistor R7 are selected based on the resistance value of the second resistor R2. In this embodiment, the resistance value of the first resistor R1 is 1 MΩ, the resistance value of the fifth resistor R5 is 1 MΩ, the resistance value of the sixth resistor R6 is 1 MΩ, and the resistance value of the seventh resistor R7 is 2.2 MΩ.

Since in the charging wake-up circuit 100 of this embodiment, the first transistor Q1, the second transistor Q2 and the third transistor Q3 are all NPN triodes, the on-off performance of the NPN triodes determines that the wake-up signal output unit 20 is configured to output a high-level signal as a wake-up signal for the charging socket control unit when the control switch SW1 is in the off state, and to output a low-level signal as the wake-up signal for the charging socket control unit when the control switch SW1 is in the on state.

Of course it can also be understood that in other embodiments, by changing the type (such as PNP type) of the first transistor Q1, the second transistor Q2 and the third transistor Q3, the wake-up signal output unit 20 may be configured to output a low-level signal as a wake-up signal for the charging socket control unit when the control switch SW1 is in the off state, and to output a high-level signal as the wake-up signal for the charging socket control unit when the control switch SW1 is in the on state.

That is, the first transistor Q1 may be a NPN triode or a PNP triode or a field effect transistor; the second transistor Q2 may be a NPN triode or a PNP triode or a field effect transistor; the third transistor Q3 may be a NPN triode or a PNP triode or a field effect transistor.

In this embodiment, the control switch SW1 is configured to be turned off when the charging socket cover is in the closed state, and to be turned on when the charging socket cover is in the open state. That is, off and on of the control switch SW1 are inversely corresponding to the opening and closing of the charging socket cover (opening of the charging socket cover corresponds to that the control switch SW1 is turned on).

Therefore, it can be understood that, in a further embodiment, the control switch SW1 may also be configured to be turned on when the charging socket cover is in the closed state, and to be turned off when the charging socket cover is in the open state. That is, off and on of the control switch SW1 are forward corresponding to the opening and closing of the charging socket cover (opening of the charging socket cover corresponds to that the control switch SW1 is turned off).

Therefore, further, the corresponding wake-up signal output unit 20 may also be configured to: output a high-level signal as a wake-up signal for the charging socket control unit when the control switch SW1 is in an off state; and output a low-level signal as the wake-up signal for the charging socket control unit when the control switch SW1 is in an on state.

Of course, in a further embodiment, correspondingly the wake-up signal output unit 20 may also be configured to: output a low-level signal as a wake-up signal for the charging socket control unit when the control switch SW1 is in an off state; and output a high-level signal as the wake-up signal for the charging socket control unit when the control switch SW1 is in an on state.

In other words, the present disclosure does not define that the off and on of the control switch SW1 corresponds to a high or low level signal, and instead defines that a change in the state of the control switch SW1 causes a change in the level signal to trigger the MCU of the charging socket to be woken up.

### Second Embodiment

This embodiment provides a charging socket including the charging wake-up circuit 100 according to any one of the above embodiments. For the sake of simplicity, the same contents are not repeated. According to the charging socket of the present disclosure, the state signal detection unit of the charging wake-up circuit is configured to generate a state input signal based on an open/closed state of a charging socket cover of an electric vehicle; the wake-up signal output unit is configured to output, based on the state input signal, a change in a level signal to serve as a wake-up signal for the charging socket control unit. The wake-up signal output unit is directly connected to the charging socket control unit, without the need to achieve to wake up the charging socket via the CAN bus of the electric vehicle. That is to say, the user can directly wake up the charging socket through the operation on a cover of the charging socket. The charging wake-up circuit according to the embodiment of the present disclosure has low costs, is low in power consumption and has good anti-interference performance, and the charging socket control unit can directly acquire the wake-up signal, that the response speed is high.

### Third Embodiment

This embodiment provides an electric vehicle including a charging socket as described above. For the sake of simplicity, the same contents are not repeated. According to the electric vehicle of the present disclosure, the state signal detection unit of the charging wake-up circuit is configured to generate a state input signal based on an open/closed state of a charging socket cover of an electric vehicle; the wake-up signal output unit is configured to output, based on the state input signal, a change in a level signal to serve as a wake-up signal for the charging socket control unit. The wake-up signal output unit is directly connected to a control unit of the charging socket, without the need to achieve to wake up the charging socket via the CAN bus of the electric vehicle. That is to say, the user can directly wake up the charging socket through the operation on a cover of the charging socket. The charging wake-up circuit according to the embodiment of the present disclosure has low costs, is low in power consumption and has good anti-interference performance, and the charging socket control unit can directly acquire the wake-up signal, that the response speed is high.

Although exemplary embodiments of the present disclosure have been illustrated, additional changes and modifications may be made to these embodiments once the basic creative concepts are known to those skilled in the art. Accordingly, the attached claims are intended to be construed to include exemplary embodiments and all changes and modifications falling within the scope of the present disclosure.

Obviously, those skilled in the art may make various changes and modifications to the embodiments of the present disclosure without deviating from the spirit and scope of the embodiments of the present disclosure. Thus, if these changes or modifications to the embodiments of the present disclosure are made within the scope of the claims and their equivalent technology of the present disclosure, the present disclosure intends to include these changes or modifications.

1. A charging wake-up circuit, wherein the charging wake-up circuit is applied to an electric vehicle, comprising:
a state signal detection unit configured to generate a state input signal based on an open state and a closed state of a charging socket cover of the electric vehicle; and
a wake-up signal output unit, wherein an input end of the wake-up signal output unit is connected to an output end of the state signal detection unit and an output end of the wake-up signal output unit is connected to a charging socket control unit of the electric vehicle, and wherein the wake-up signal output unit is configured to output, based on the state input signal, a change in a level signal to serve as a wake-up signal for the charging socket control unit.

2. The charging wake-up circuit according to claim 1, wherein the state signal detection unit comprises a control switch and a second resistor, the control switch is connected in parallel with the second resistor, one end of the second resistor is connected to an on-board power supply of the electric vehicle and the input end of the wake-up signal output unit respectively, and the other end of the second resistor is grounded.

3. The charging wake-up circuit according to claim 2, wherein the control switch is configured to be turned off when the charging socket cover is in a closed state, and to be turned on when the charging socket cover is in an open state.

4. The charging wake-up circuit according to claim 3, wherein the wake-up signal output unit is configured to:
output a high-level signal as a wake-up signal for the charging socket control unit when the control switch is in an off state, and output a low-level signal as the wake-up signal for the charging socket control unit when the control switch is in an on state; or
output a low-level signal as a wake-up signal for the charging socket control unit when the control switch is in an off state, and output a high-level signal as the wake-up signal for the charging socket control unit when the control switch is in an on state.

5. (canceled)

6. The charging wake-up circuit according to claim 2, wherein the control switch is configured to be turned on when the charging socket cover is in a closed state, and to be turned off when the charging socket cover is in an open state.

7. The charging wake-up circuit according to claim 6, wherein the wake-up signal output unit is configured to:
output a high-level signal as a wake-up signal for the charging socket control unit when the control switch is in an off state, and output a low-level signal as the wake-up signal for the charging socket control unit when the control switch is in an on state; or
output a low-level signal as a wake-up signal for the charging socket control unit when the control switch is in an off state, and output a high-level signal as the wake-up signal for the charging socket control unit when the control switch is in an on state.

8. (canceled)

9. The charging wake-up circuit according to claim 2, further comprising a state signal stabilization unit, wherein an input end of the state signal stabilization unit is connected to an output end of the state signal detection unit, and an output end of the state signal stabilization unit is connected to the input end of the wake-up signal output unit, for stabilizing the state input signal.

10. The charging wake-up circuit according to claim 9, wherein the state signal stabilization unit comprises a first transistor and a third transistor, the first transistor and the third transistor constituting a proportional constant-current source configured to provide a constant-current state input signal to the wake-up signal output unit.

11. The charging wake-up circuit according to claim 10, wherein the state signal stabilization unit further comprises a fourth resistor and a third resistor, the fourth resistor serves as a negative feedback resistor for the first transistor, and the third resistor and the second resistor serve as negative feedback resistors for the third transistor based on the on and off of the control switch.

12. The charging wake-up circuit according to claim 11, wherein:
the state signal stabilization unit further comprises a first resistor, one end of the first resistor is connected to the on-board power supply and the other end of the first resistor is connected to a first switching end of the third transistor, and a second switching end of the third transistor is connected to one end of the second resistor and the other end of the second resistor is connected to one end of the third resistor, the other end of the third resistor being grounded;
a first control end of the first transistor is connected to a second control end of the third transistor, a first switching end of the first transistor is connected to the input end of the wake-up signal output unit, and a second switching end of the first transistor is grounded via the fourth resistor; and
a common port of the first control end and the second control end is connected between the first resistor and the first switching end of the third transistor.

13. The charging wake-up circuit according to claim 12, wherein the wake-up signal output unit comprises a second transistor, a third control end of the second transistor is connected to the first switching end of the first transistor via a sixth resistor, a first switching end of the second transistor is connected to a signal input end of the charging socket control unit via a ninth resistor, and a second switching end of the second transistor is grounded.

14. The charging wake-up circuit according to claim 13, further comprising a seventh resistor, wherein the third control end is grounded via the seventh resistor.

15. The charging wake-up circuit according to claim 14, further comprising a fifth resistor, wherein one end of the fifth resistor is connected to the on-board power supply, and the other end of the fifth resistor is connected to the sixth resistor and the first switching end of the first transistor respectively.

16. (canceled)

17. The charging wake-up circuit according to claim 15, further comprising an eighth resistor, wherein one end of the eighth resistor is connected to the on-board power supply, and the other end of the eighth resistor is connected to the ninth resistor.

18. The charging wake-up circuit according to claim 12, wherein the first resistor has a resistance value of 0.5 MΩ to 1.2 MΩ.

19. The charging wake-up circuit according to claim 2, wherein the second resistor has a resistance value of 3.3 KΩ to 4 KΩ.

20. The charging wake-up circuit according to claim 15, wherein the fifth resistor has a resistance value of 0.5 MΩ to 1.2 MΩ; and the sixth resistor has a resistance value of 0.5 MΩ to 1.2 MΩ.

21. The charging wake-up circuit according to claim 15, wherein the seventh resistor has a resistance value of 2 MΩ to 3 MΩ.

22. A charging socket comprising the charging wake-up circuit according to claim 1.

23. An electric vehicle comprising the charging socket according to claim 22.
